(19) United States
(12) Patent Application Publication
(10) Pub. No.: US 2020/0394091 A1
(43) Pub. Date: Dec. 17, 2020

(54) FAILURE ANALYSIS SUPPORT SYSTEM, FAILURE ANALYSIS SUPPORT METHOD, AND COMPUTER READABLE RECORDING MEDIUM

(71) Applicant: Hitachi, Ltd., Tokyo (JP)

(72) Inventors: Arata KOKUBUN, Tokyo (JP); Yusuke ASAI, Tokyo (JP); Takaki KURODA, Tokyo (JP); Masashi YAKU, Tokyo (JP); Hironobu SAKATA, Tokyo (JP); Taiki EIRAKU, Tokyo (JP); Hidenobu MURAMATSU, Tokyo (JP)

(73) Assignee: Hitachi, Ltd., Tokyo (JP)

(21) Appl. No.: 16/814,899

(22) Filed: Mar. 10, 2020

(30) Foreign Application Priority Data
Jun. 17, 2019 (JP) 2019-111889

(51) Int. Cl. G06F 11/07

(52) U.S. Cl. CPC G06F 11/079; G06F 11/0769; G06F 11/0757

(57) ABSTRACT

A failure analysis support system calculates a failure analysis period based on a metric performance value of a bottleneck candidate resource and a metric base value corresponding to the metric performance value, identifies a bottleneck candidate related resource related to the bottleneck candidate resource by referring to inter-resource relation information, calculates an evaluation value of the bottleneck candidate related resource based on a metric performance value of the bottleneck candidate related resource and a metric base value corresponding to the metric performance value, identifies a to-be-displayed bottleneck candidate related resource from the bottleneck candidate related resource based on the evaluation value, and displays a mutual relationship between display resources including a base point resource, a base point-related resource, the bottleneck candidate resource, and the to-be-displayed bottleneck candidate related resource, and a status of the display resources at each time point in the failure analysis period.

### CROSS-REFERENCE TO RELATED APPLICATIONS

This application is based upon and claims the benefit of priority from Japanese Patent Application No. 2019-111889 filed in Japan Patent Office on Jun. 17, 2019, the contents of which are hereby incorporated by reference.

### BACKGROUND

The present disclosure relates to a technique for supporting failure analysis of a computer system.

As computer systems have become larger in scale and have also become more complex due to mixed resources for various applications in the computer systems, phenomena caused by failures related to performance occurring in such computer systems have also become more complex. As a result, the cost of analyzing the cause when a failure occurs increases. Under such circumstances, various techniques and various methods have been proposed for supporting the cause analysis of a failure of a computer system. For example, there is a technique that improves the visibility of the configuration of a computer system and facilitates cause analysis by displaying a topology that represents a mutual relationship with respect to some resources narrowed down from the resources included in the computer system.

Japanese Patent Application Publication No. 2016-81507 discloses a management system capable of effective narrow down in a computer system. The management system displays a list of elements of some of a plurality of element types, and receives a selection of two or more elements from the list. Then, the management system displays a topology which is composed of the selected two or more elements and elements related to the selected two or more elements (related elements), and in which the selected two or more elements and the related elements are classified by element type.

### SUMMARY

In failure analysis in a computer system, how the failure has changed in the computer system over time may help to find the cause of the failure. However, the technique disclosed in Japanese Patent Application Publication No. 2016-81507 displays a topology in which elements related to each other are classified by element type, which does not accordingly allow an analyst to visually recognize a time change.

One object of the present disclosure is to provide a technique for supporting efficient analysis of a failure in a computer system.

A failure analysis support system according to one embodiment of the present disclosure is a failure analysis support system for supporting a failure analysis for a computer system including a plurality of resources. The failure analysis support system includes a management information storage unit configured to store inter-resource relation information indicating a relationship between the plurality of resources, metric base values that are each a base value determined for each metric of the plurality of resources, and metric performance values that are each a measured value of each metric of the plurality of resources at each time point; a failure analysis period identification unit configured to identify a base point-related resource related to a base point resource that is a base point of the failure analysis by referring to the inter-resource relation information, display the base point resource and the base point-related resource to receive a designation of a bottleneck candidate resource, and calculate a failure analysis period that is a period of time to be subjected to the failure analysis based on a metric performance value of the bottleneck candidate resource and a metric base value corresponding to the metric performance value; a display resource identification unit configured to identify a bottleneck candidate related resource related to the bottleneck candidate resource by referring to the inter-resource relation information, calculate an evaluation value of the bottleneck candidate related resource based on a metric performance value of the bottleneck candidate related resource and a metric base value corresponding to the metric performance value, and identify a to-be-displayed bottleneck candidate related resource that is a resource to be displayed from the bottleneck candidate related resource based on the evaluation value; and a resource status reproduction display unit configured to display a screen with an appearance to show a mutual relationship between display resources including the base point resource, the base point-related resource, the bottleneck candidate resource, and the to-be-displayed bottleneck candidate related resource, and a status of the display resources at each time point in the failure analysis period.

According to the embodiment of the present disclosure, it is possible to support efficient analysis of a failure in a computer system.

### BRIEF DESCRIPTION OF THE DRAWINGS

FIG. 1 is a block diagram illustrating a configuration of a computer system and a management system according to an embodiment;

FIG. 2 is a diagram illustrating an example of an element topology configuration of the computer system to be managed by a management server according to the embodiment;

FIG. 3 illustrates an example of a resource list table according to the embodiment;

FIG. 4 illustrates an example of an inter-resource relation table according to the embodiment;

FIG. 5 illustrates an example of a metric performance value table according to the embodiment;

FIG. 6 illustrates an example of an event information table according to the embodiment;

FIG. 7 is a flowchart illustrating an outline of processing in the management server according to the embodiment;

FIG. 8 is a flowchart illustrating a processing example of a failure analysis period identification unit according to the embodiment;

FIG. 9 is a flowchart illustrating a processing example of a display resource identification unit according to the embodiment;

FIG. 10 is a flowchart illustrating a processing example in which the display resource identification unit according to the embodiment additionally displays the contents of a display resource list on a topology;

FIG. 11 is a flowchart illustrating an example of a processing example in which a resource status reproduction display unit according to the embodiment reproduces changes in status of resources in the topology;

FIG. 12 is a flowchart illustrating an example of a topology display process for a target image frame according to the embodiment;

FIG. 13 is a diagram illustrating a display example of events that have occurred in resources constituting a topology according to the embodiment;

FIG. 14 illustrates a specific example of a failure analysis period identified by the failure analysis period identification unit according to the embodiment;

FIG. 15 illustrates an example of a base value table according to the embodiment;

FIG. 16 illustrates an example of a parameter table for the failure analysis period according to the embodiment;

FIG. 17 is a flowchart illustrating an example of a calculation process for outputting a list of display resources from a list of metric performance values of related resources according to the embodiment;

FIG. 18 is a flowchart illustrating an example of calculating a first evaluation value x₁ by a first logic according to the embodiment;

FIG. 19 is a flowchart illustrating an example of calculating a second evaluation value x₂ by a second logic according to the embodiment; and

FIG. 20 is a flowchart illustrating an example of calculating a third evaluation value x₃ by a third logic according to the embodiment.

### DETAILED DESCRIPTION OF THE EMBODIMENT

Embodiments of the present disclosure will be described below with reference to the drawings.

### Embodiment

### System Configuration

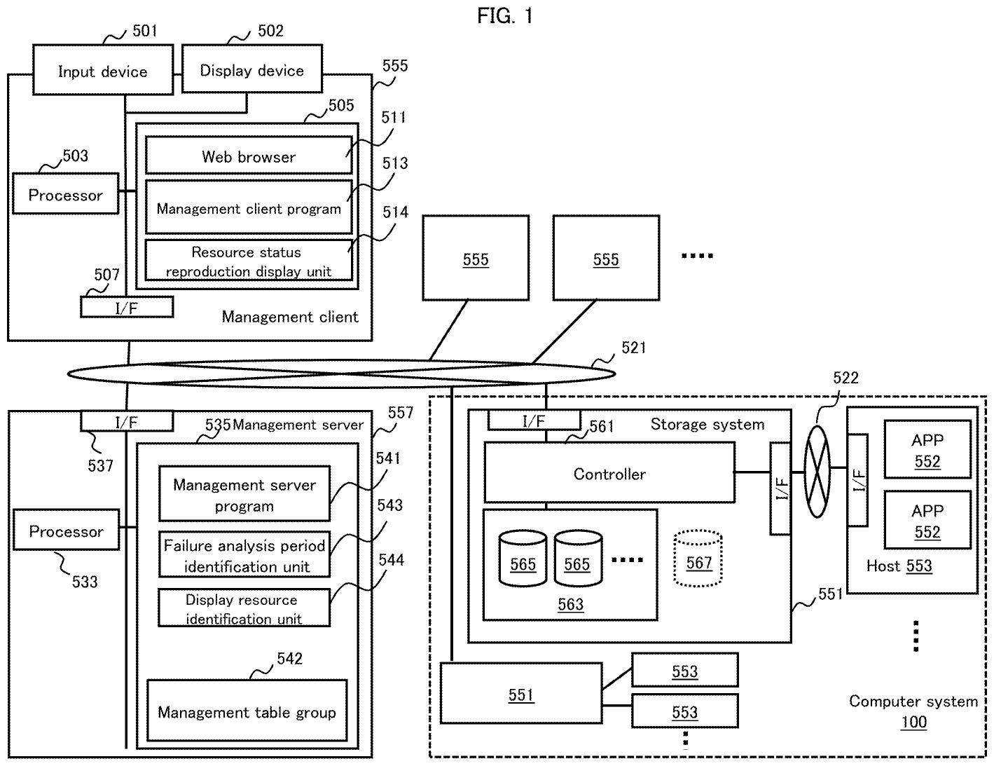

FIG. 1 illustrates a configuration of a computer system and a management system according to an embodiment.

A computer system 100 includes one or more hosts 553 and one or more storage systems 551 coupled to the one or more hosts 553. To the storage system 551, for example, the host 553 is coupled via a communication network 522 (e.g., SAN (Storage Area Network) or LAN (Local Area Network)).

The management system includes a management server 557 and one or more management clients 555 coupled to the management server 557. To the management server 557, the management client 555 is coupled via a communication network (e.g., LAN, WAN (World Area Network) or the Internet) 521.

### Management Target Devices

The storage system 551 includes a physical storage device group 563 and a controller 561 coupled to the physical storage device group 563.

The physical storage device group 563 has one or more PGs (Parity Groups). The PG may be called a RAID (Redundant Array of Independent (or Inexpensive) Disks) group. The PG is composed of a plurality of physical storage devices, and stores data according to a predetermined RAID level. The physical storage device is, for example, an HDD (Hard Disk Drive) or an SSD (Solid State Drive).

The storage system 551 has a plurality of logical volumes. As the logical volume, there is a real logical volume (real volume) 565 based on the PG, and a virtual logical volume (virtual volume) 567 according to thin provisioning or storage virtualization technology. One storage system 551 does not always have a plurality of types of logical volumes. For example, the storage system 551 may have only the real volume 565 as a logical volume. The virtual volume according to thin provisioning is allocated a storage area from a pool. The pool is a storage area group based on one or more physical storage devices (e.g., PGs), and may be, for example, a set of one or more logical volumes. The pool may be a pool that stores a difference between an original logical volume and its snapshot, instead of a pool having a storage area allocated to a virtual volume according to thin provisioning.

The controller 561 includes a plurality of devices, for example, a port, an MPB (a blade (circuit board) including one or a plurality of microprocessors (MP)), and a cache memory. For example, the port receives an I/O (Input/Output) command (write command or read command) from the host 553, and the MP of the MPB controls I/O of data according to the I/O command. Specifically, for example, the MP identifies a logical volume that is to be subjected to the I/O from the received I/O command, and performs data I/O on the identified logical volume. Data to be subjected to the I/O on the logical volume is temporarily stored in the cache memory.

The host 553 may be a physical computer or a virtual computer. On the host 553, one or more application programs (APP) 552 are executed. When the APP 552 is executed, an I/O command designating a logical volume is transmitted from the host 553 to the storage system 551.

As described above, the computer system 100 includes a plurality of tiered elements. The plurality of elements are physical or logical components, and may be set in any unit. Here, the elements include, by way of specific examples, the APP 552, the host 553, the storage system 551, the controller 561, the port, the MPB, the cache memory, the logical volume, and the PG. The elements are associated with each other between upper and lower tiers. In the present embodiment, for convenience, of the plurality of elements, an element higher than a predetermined boundary is referred to as a “node”, and an element lower than the predetermined boundary is referred to as a “component”. In the present embodiment, the node is an element on the host 553 side, and the component is an element on the storage system 551 side. It is noted that, by grouping a plurality of elements in the same tier (a plurality of elements associated with a common element in a higher tier), an element higher than the elements in the same tier may be defined. In other words, the “element” may be a real element such as an APP or a logical volume, or a virtual element which is a group of a plurality of real elements.

### Management Client

The management client 555 includes an input device 501, a display device 502, a storage device (e.g., memory) 505, a communication interface device (hereinafter, I/F) 507, and a processor (e.g., CPU (Central Processing Unit)) 503 coupled to them. The input device 501 is, for example, a pointing device and a keyboard. The display device 502 is, for example, a device having a physical screen on which information is displayed. A touch screen in which the input device 501 and the display device 502 are integrated may be used. The I/F 507 is coupled to the communication network 521, so that the management client 555 can communicate with the management server 557 via the I/F 507. It is noted that a part or all of the communication network 521 and the network connecting the host 553 and the storage system 551 may be common.

Of a main storage device and an auxiliary storage device, the storage device 505 includes, for example, at least the main storage device (typically, a memory). The storage device 505 can store a computer program executed by the processor 503 and information used by the processor 503. Specifically, for example, the storage device 505 stores a Web browser 511 and a management client program 513. The management client program 513 may be an RIA (Rich Internet Application). Specifically, for example, the management client program is a program file, which may be downloaded from the management server 557 (or another computer) and stored in the storage device 505.

### Management Server

The management server 557 includes a storage device 535, an I/F 537, and a processor (e.g., a CPU (Central Processing Unit)) 533 coupled to them. The I/F 537 is coupled to the communication network 521, so that the management server 557 can communicate with the management client 555 via the IT 537. The management server 557 can receive an instruction according to a user operation via the IT 537 and draw a GUI object in a layout area. Therefore, the I/F 537 is an example of an I/O interface device. It is noted that the “layout area” is an area where a GUI object can be drawn (arranged). The entire or partial range of the layout area is a display range in an image frame (e.g., a window) displayed by the Web browser 511 (or the management client program 513). A display image (including the GUI object) in the image frame of the layout area where the GUI object is drawn may be referred to as a display screen (GUI screen). Of objects drawn in the layout area, objects overlapping the display range are displayed on a physical screen of the display device 502. There, drawing an object in the layout area is substantially an example of displaying the object.

Of a main storage device and an auxiliary storage device, the storage device 535 includes, for example, at least the main storage device (typically, a memory). The storage device 535 can store a computer program executed by the processor 533 and information used by the processor 533. Specifically, for example, the storage device 535 stores a management server program 541 and a management table 542. The management table 542 includes a table defining a tier relationship (configuration information) between a plurality of elements included in the computer system and/or a table holding failure information on each element. These pieces of information may be collected by the management server program, or may be obtained by accessing another management system having the information. The elements as used herein include the management client 555 managed by the management server, a node such as the storage system 551 and the host 553, and components of each node (the physical storage device group 563 included in the storage system 551, the APP 552 included in the host 553, etc.).

The management server program 541 receives an instruction according to a user operation from the management client 555, and transmits information drawn in the layout area to the management client 555.

### Cooperation Between Management Server and Management Client

The GUI display according to a user operation is realized by a cooperative process of the management server program 541, the Web browser 511 (or the RIA execution environment of the client), and the management client program 513. The following shows three examples of the cooperation. It is noted that, in the present embodiment, a case where Cooperation Example 2 is applied will be described, but the same applies to a case where Cooperation Example 1 is applied.

### Cooperation Example 1

The management server program 541 transmits at least part of the information stored in the table 542 to the Web browser 511 (or the management client program 513). The Web browser 511 (or the management client program 513) stores the transmitted information in the storage device 505 as temporary information. The Web browser 511 (or the management client program 513) draws a GUI object in the layout area based on an instruction according to a user operation and the temporary information (e.g., newly draws, enlarges, or reduces the GUI object).

### Cooperation Example 2

The management server program 541 receives an instruction according to a user operation on the display screen from the Web browser 511 (or the management client program 513). The management server program 541 creates display information on a GUI object based on the received instruction and the table 542, and transmits the display information to the Web browser 511 (or the management client program 513). The Web browser 511 (or the management client program 513) receives the display information, and draws the GUI object in the layout area according to the display information. That is, the management server program 541 draws the GUI object in the layout area. When a user operation is performed on the GUI, the Web browser 511 (or the management client program 513) transmits an instruction according to the user operation to the management server program 541.

The management server 557 includes a failure analysis period identification unit 543 configured to identify a failure analysis period, and a display resource identification unit 544 configured to identify a resource to be displayed. The management client 555 includes a resource status reproduction display unit 514 configured to perform additional display of resources to a topology and a resource status reproduction process.

The management server 557 transmits the information identified by the failure analysis period identification unit 543 and the display resource identification unit 544 to the management client 555. The resource status reproduction display unit 514 in the management client 555 performs a display process according to the information transmitted from the management server 557. It is noted that details of these processes will be described later.

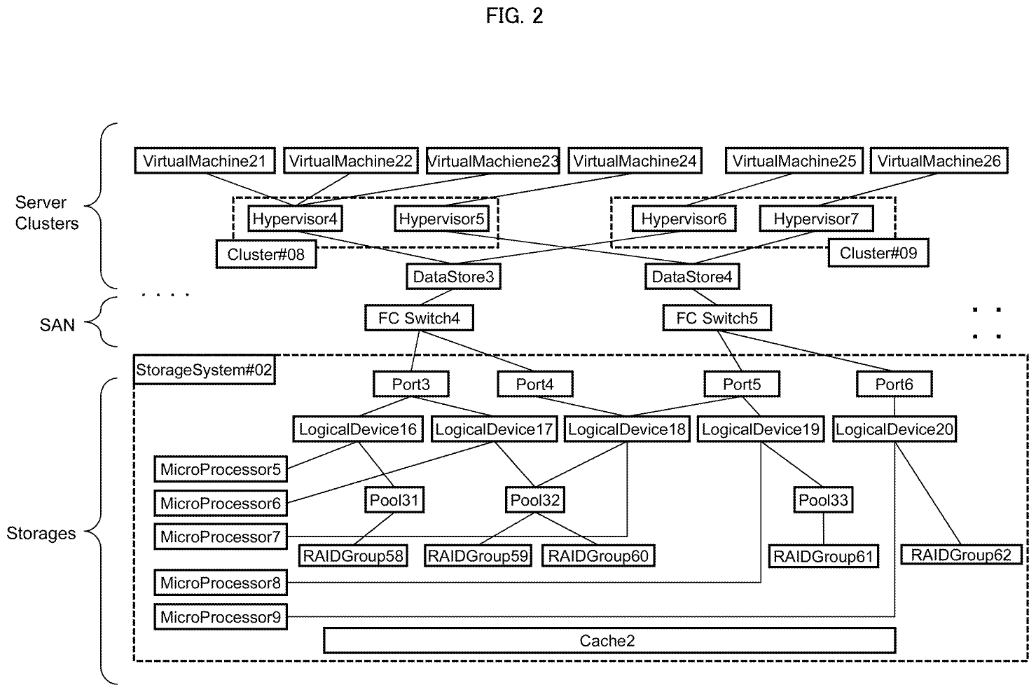

FIG. 2 illustrates an example of an element topology configuration of the computer system 100 to be managed by the management server. FIG. 2 illustrates a mutual relationship between elements constituting the computer system 100 by a topology.

In FIG. 2, the computer system 100 has a configuration in which Server Clusters and Storages are coupled to each other via a SAN, and elements that constitute them are associated with each other in tiered form. The Server Clusters correspond to the hosts 553 of the computer system 100, and have a configuration in which VirtualMachines, Hypervisors, and DataStores are arranged in multiple tiers. The SAN corresponds to the communication network 522 of the computer system 100, and is composed of FC Switches. Storages correspond to the storage systems 551 of the computer system 100, and have a configuration in which Ports, LogicalDevices, MicroProcessors, Pools, RAIDGroups, and Caches are arranged in multiple tiers.

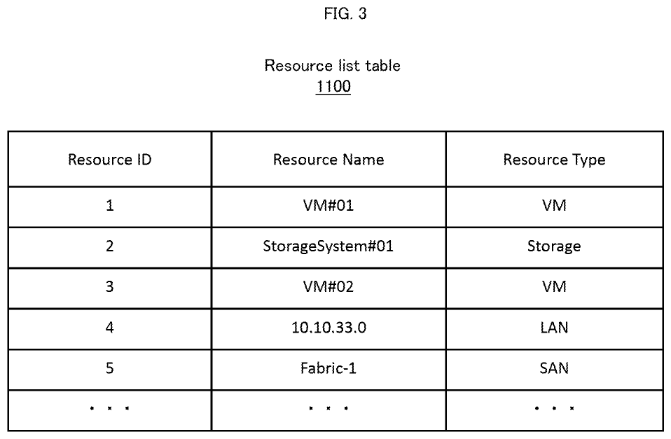

FIG. 3 illustrates an example of a resource list table 1100. The resource list table 1100 stores information on resources included in the computer system 100. A resource ID and a resource name may be assigned to each of all or some of the elements of the computer system 100 and registered in the resource list table 1100 as resources to be managed.

The resource list table 1100 is used to manage information related to the resources as records. Each record has, as data items, a resource ID, a resource name, and a resource type. The resource ID is an identifier for uniquely identifying a resource. The resource name is a name for uniquely identifying the resource. The resource type is information indicating the type of the resource. The resource name may be any name assigned by the user. In the present example, a name that allows the user to easily understand the correspondence with the resource type may be used because the resource name is also used for displaying a topology screen. For example, the first line of the resource list table 1100 illustrated in FIG. 3 indicates that the resource with a resource ID of “1” has a resource name of “VM #1” and a resource type of “VM (VirtualMachine)”. The information of the records of the resource list table 1100 is collected from a monitor target device (the computer system 100 in FIG. 1) by the management server program.

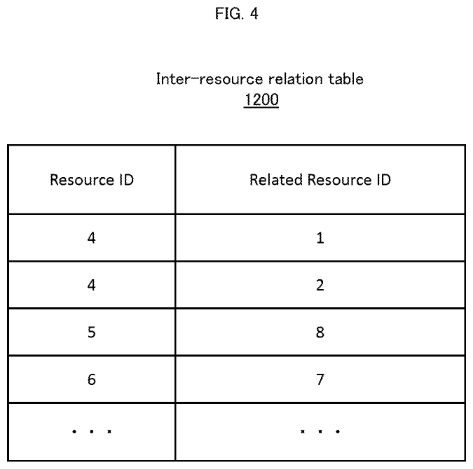

FIG. 4 illustrates an example of an inter-resource relation table 1200.

The inter-resource relation table 1200 is used to manage pieces of information indicating relationships between resources as records. Each record has, as data items, a resource ID and a related resource ID. For example, the first line of the inter-resource relation table 1200 illustrated in FIG. 4 indicates that the resource with a resource ID of “4” is related to the resource with a resource ID of “1”.

One resource related to a plurality of resources is managed by a plurality of records. For example, as illustrated in FIG. 4, in a case where the resource with a resource ID of “4” is related to the resource with resource ID “1” and the resource with a resource ID of “2”, the inter-resource relation table 1200 has a record with a resource ID of “4” and a related resource ID of “1”, and a record with a resource ID of “4” and a related resource ID of “2”.

The information of the records of the inter-resource relation table 1200 is collected from a monitor target device (the computer system 100 in FIG. 1) by the management server program.

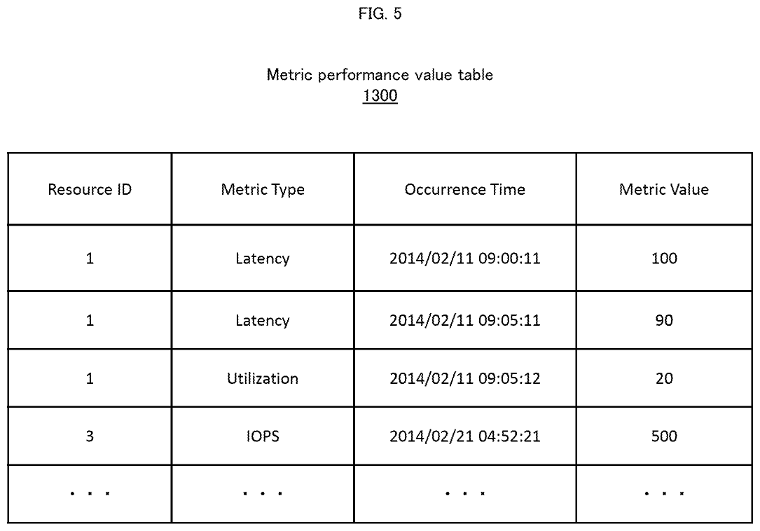

FIG. 5 illustrates an example of a metric performance value table 1300.

The metric performance value table 1300 is used to manage pieces of information related to resource metrics as records. Each record has, as data items, a resource ID, a metric type, a collection time, and a metric performance value. For example, the first line of the metric performance value table 1300 illustrated in FIG. 5 indicates that the resource with a resource ID of “1”, a metric type of “Latency”, and a collection time of “2014/02/11 09:00:11” has a metric performance value of “100”.

The information of the records of the metric performance value table 1300 is collected from a monitor target device (the computer system 100 in FIG. 1) by the management server program.

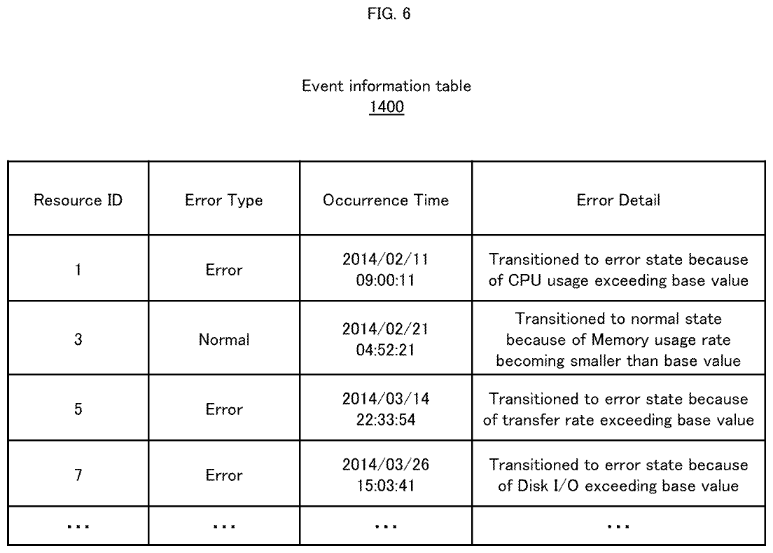

FIG. 6 illustrates an example of an event information table 1400.

The event information table 1400 is used to manage pieces of information on events that have occurred in resources as records. The events include a transition from a normal state to an error state and a transition from an error state to a normal state. Each record of the event information table 1400 has, as data items, a resource ID, an error type, an occurrence time point, and an error message. For example, the first line of the event information table 1400 illustrated in FIG. 6 indicates that, in the resource with a resource ID of “1”, an event of error type of “Error” occurs at an occurrence time point of “2014/02/11 09:00:11” and the error message at that time indicates “Transitioned to error state because of CPU usage exceeding base value”.

The event information table 1400 may hold a record for a case where the metric performance value exceeds the base value (metric base value). The information of the records of the event information table 1400 may be results of the management server program determining metric performance values collected from a monitor target device (the computer system 100 in FIG. 1).

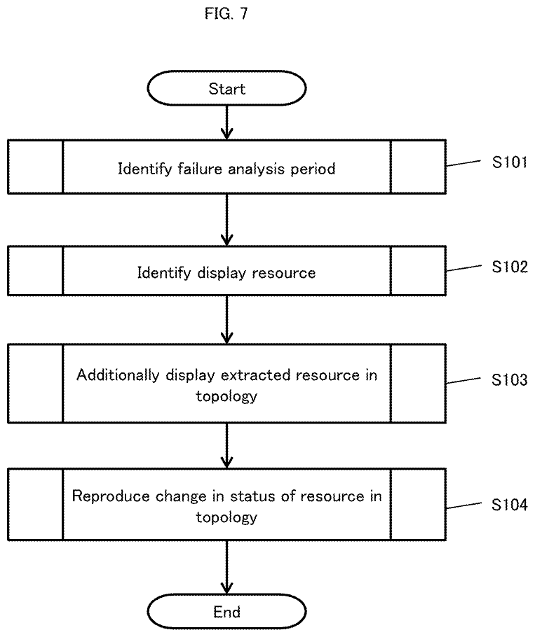

FIG. 7 is a flowchart illustrating an outline of processing in the management server.

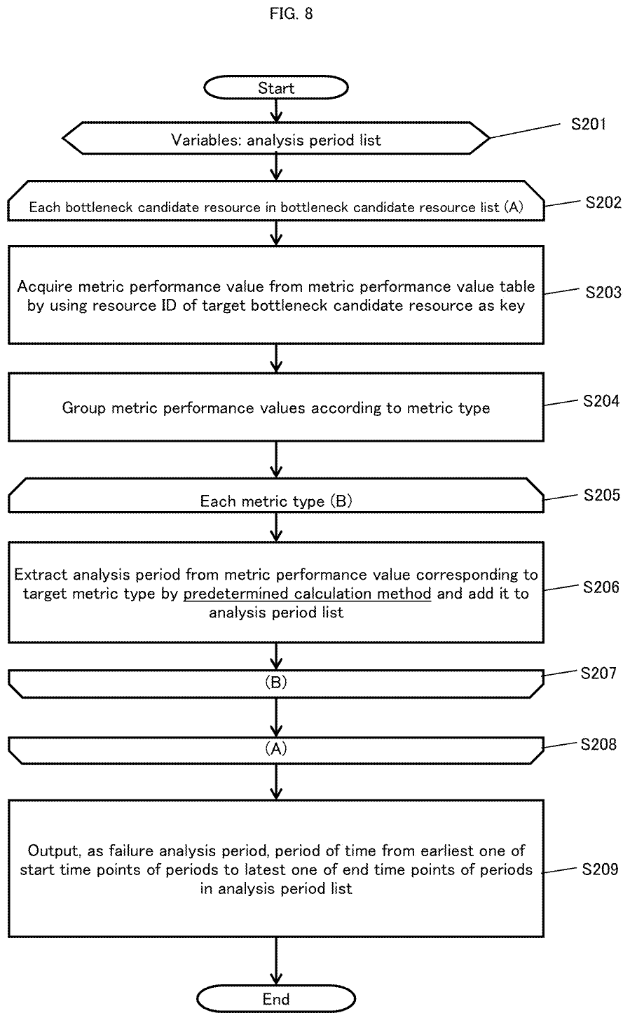

In cooperation with the management server program 541, the failure analysis period identification unit 543 identifies a resource serving as a base point of the failure analysis (base point resource) and a resource related to the base point resource (base point-related resource), displays the resources as a topology, selects a bottleneck candidate resource from the displayed resources, and records the selected bottleneck candidate resources in a bottleneck candidate resource list. In this state, the failure analysis period identification unit 543 outputs the failure analysis period based on the bottleneck candidate resource list (S101). The base point resource is designated by the user, for example. The base point-related resource is identified by referring to the inter-resource relation table 1200. The bottleneck candidate resource list includes at least one bottleneck candidate resource. The bottleneck candidate resource is a resource estimated by the user to cause a failure due to the resource becoming a bottleneck, and is input or selected by the user. It is noted that details of this processing will be described later (see FIG. 8).

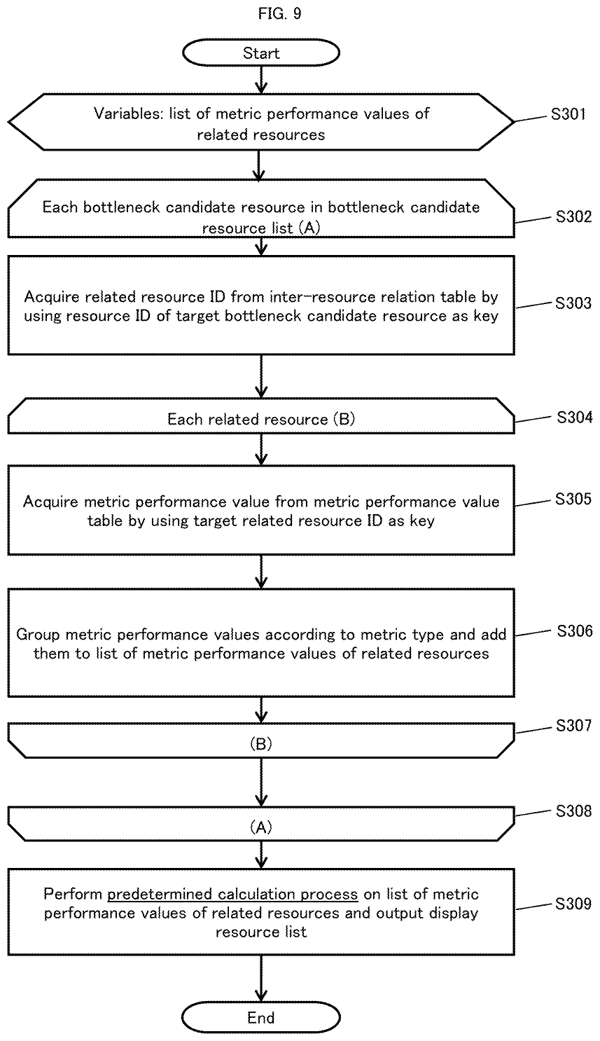

The display resource identification unit 544 identifies a display resource based on the bottleneck candidate resource, a related resource list, and the failure analysis period (S102). The related resource list indicates resource(s) related to the bottleneck candidate resource(s), and is identified by using the inter-resource relation table 1200. The failure analysis period is that output in S101. It is noted that details of this processing will be described later (see FIG. 9).

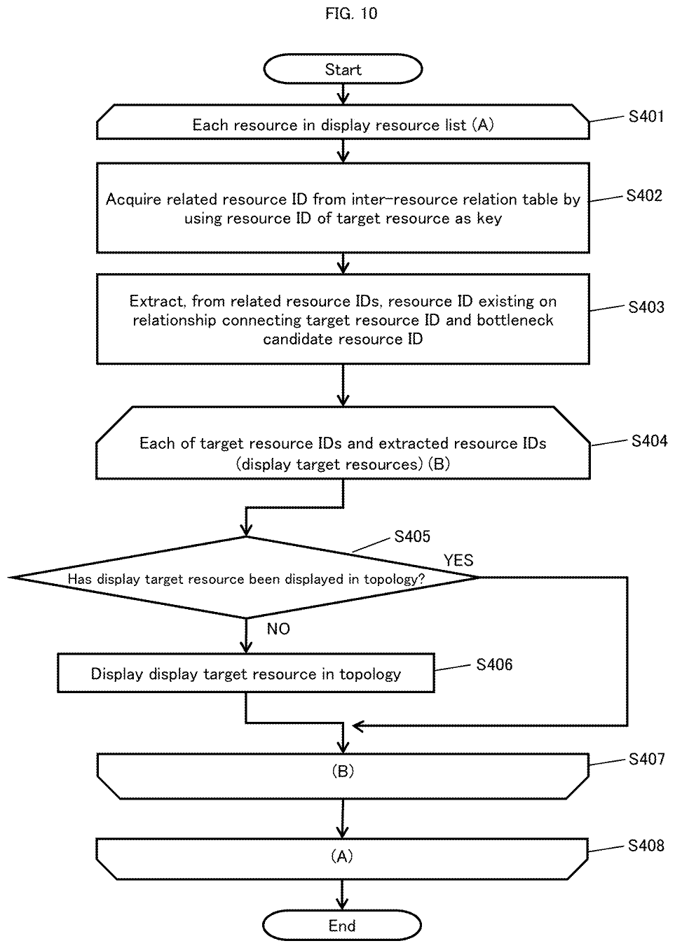

The resource status reproduction display unit 514 additionally displays the display resource identified in S102 on the topology (S103). It is noted that details of this processing will be described later (see FIG. 10).

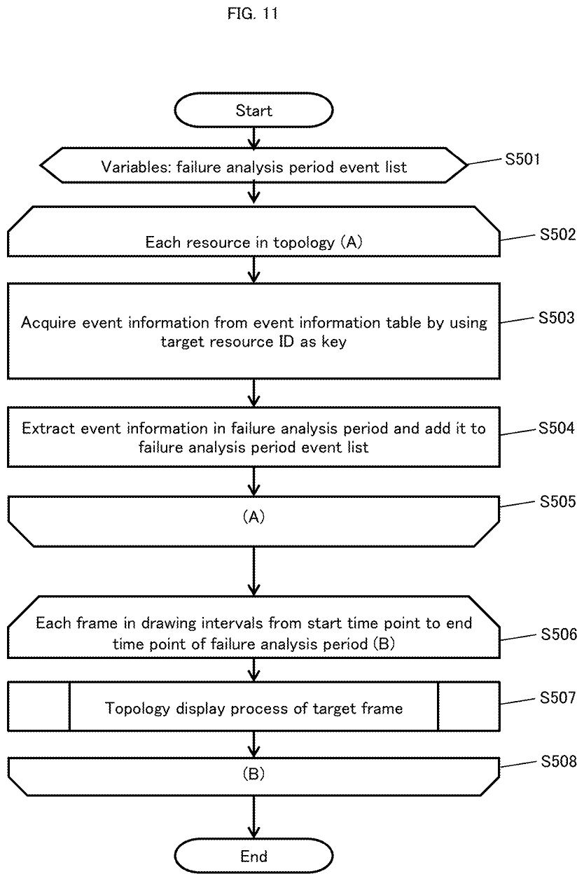

The resource status reproduction display unit 514 reproduces a change in status of the resource in the topology in the failure analysis period as an animation (S104). It is noted that details of this processing will be described later (see FIG. 11).

FIG. 8 is a flowchart illustrating a processing example of the failure analysis period identification unit 543. This processing corresponds to the details of S101 in FIG. 7.

The failure analysis period identification unit 543 prepares variables for an analysis period list (S201).

The failure analysis period identification unit 543 selects the bottleneck candidate resources included in the bottleneck candidate resource list in sequence, and performs a loop process from S202 to S208 (S202). The bottleneck candidate resource selected as the target for the loop process in S202 is referred to as the target bottleneck candidate resource.

The failure analysis period identification unit 543 acquires metric performance values from the metric performance value table 1300 by using the resource ID of the target bottleneck candidate resource as a key (S203).

The failure analysis period identification unit 543 groups the metric performance values acquired in S203 by metric type (S204).

The failure analysis period identification unit 543 selects the metric types used in the grouping in S204 in sequence, and performs a loop process from S205 to S207 (S205). The metric type selected as the target for the loop process in S205 is referred to as the target metric type.

The failure analysis period identification unit 543 extracts an analysis period from the metric performance values corresponding to the target metric type by a predetermined calculation method, and adds the extracted analysis period to the analysis period list (S206).

In the failure analysis period identification unit 543, if all the metric types have been selected in S205, the processing proceeds to S208, and if unselected metric type(s) remain in S205, the processing returns to S205 (S207).

In the failure analysis period identification unit 543, if all the bottleneck candidate resources have been selected in S202, the processing proceeds to S209, and if unselected bottleneck candidate resource(s) remain in S202, the processing returns to S202 (S208).

The failure analysis period identification unit 543 outputs, as the failure analysis period, a period of time from the earliest one of the start time points of the analysis periods to the latest one of the end time points of the analysis periods in the analysis period list (S209). Then, the processing ends.

FIG. 9 is a flowchart illustrating a processing example of the display resource identification unit 544. This processing corresponds to S102 in FIG. 3.

The display resource identification unit 544 prepares variables for a list of metric performance values of related resources (S301).

The display resource identification unit 544 selects the bottleneck candidate resources included in the bottleneck candidate resource list in sequence, and performs a loop process from S302 to S308 (S302). The bottleneck candidate resource selected as the target for the loop process in S302 is referred to as the target bottleneck candidate resource.

The display resource identification unit 544 acquires related resource IDs from the inter-resource relation table 1200 by using the resource ID of the target bottleneck candidate resource as a key (S303).

The display resource identification unit 544 selects the related resource IDs acquired in S303 in sequence, and performs a loop process from S304 to S307 (S304). The related resource ID selected as the target for the loop process in S304 is referred to as the target related resource ID.

The display resource identification unit 544 acquires metric performance values from the metric performance value table 1300 by using the target related resource ID as a key (S305).

The display resource identification unit 544 groups the metric performance values acquired in S305 by metric type, and adds them to the list of metric performance values of related resources (S306).

In the display resource identification unit 544, if all the related resource IDs have been selected in S305, the processing proceeds to S308, and if unselected related resource ID(s) remain in S305, the processing returns to S304 (S307).

In the display resource identification unit 544, if all the bottleneck candidate resources have been selected in S302, the processing proceeds to S309, and if unselected bottleneck candidate resource(s) remain in S302, the processing returns to S302 (S308).

The display resource identification unit 544 performs a predetermined calculation process on the list of metric performance values of related resources, and outputs a display resource list (S309). Then, the processing ends.

FIG. 10 is a flowchart illustrating a processing example in which the display resource identification unit 544 additionally displays the contents of the display resource list on the topology. This processing corresponds to S103 in FIG. 3.

The display resource identification unit 544 selects the resource IDs included in the display resource list output in S309 in sequence, and performs a loop process from S401 to S408 (S401). The resource ID selected as the target for the loop process in S401 is referred to as the target resource ID.

The display resource identification unit 544 acquires related resource IDs from the inter-resource relation table 1200 by using the target resource ID as a key (S402).

The display resource identification unit 544 extracts, from the related resource IDs, a resource ID existing on the relationship connecting the target resource ID and the bottleneck candidate resource ID (hereinafter, referred to as a “bottleneck candidate related resource ID”) (S403).

The display resource identification unit 544 performs a loop process from S404 to S407 on each of the target resource IDs and the extracted bottleneck candidate related resource IDs (S404). The target resource ID or the bottleneck candidate related resource ID selected as the target for the loop process in S404 is referred to as the display target resource ID.

The display resource identification unit 544 determines whether or not the resource with the display target resource ID has been displayed in the topology (S405).

In the display resource identification unit 544, if the resource with the display target resource ID has not been displayed in the topology (S405: NO), the resource with the display target resource ID is displayed in the topology (S406), and the processing proceeds to S407.

In the display resource identification unit 544, if the resource with the display target resource ID has been displayed in the topology (S405: YES), the processing proceeds to S407.

In the display resource identification unit 544, if all the display resource IDs and intermediate related resource IDs have been selected in S404, the processing proceeds to S408, and if unselected display resource ID(s) or bottleneck candidate related resource ID(s) remain in S404, the processing returns to S404 (S407).

In the display resource identification unit 544, if all the display resource IDs have been selected in S401, the processing ends, and if unselected display resource ID(s) remain in S401, the processing returns to S401 (S408).

FIG. 11 is a flowchart illustrating a processing example in which the resource status reproduction display unit 514 reproduces changes in status of resources in the topology. This processing corresponds to S104 in FIG. 3.

The resource status reproduction display unit 514 prepares variables for a failure analysis period event list (S501).

The resource status reproduction display unit 514 selects the resource IDs of the resources constituting the topology in sequence, and performs a loop process from S502 to S505 (S502). The resource ID selected as the target for the loop process in S502 is referred to as the target resource ID.

The resource status reproduction display unit 514 acquires pieces of event information from the event information table 1400 by using the target resource ID as a key (S503).

The resource status reproduction display unit 514 adds, to the failure analysis period event list, a piece of event information that occurred in the failure analysis period output in S209, of the pieces of event information acquired in S503 (S504).

In the resource status reproduction display unit 514, if all the resource IDs have been selected in S502, the processing proceeds to S506, and if unselected resource ID(s) remain in S502, the processing returns to S502.

The resource status reproduction display unit 514 selects the image frames in drawing intervals from the start time point to the end time point of the failure analysis period in sequence, and performs a loop process from S506 to S508 (S505). The image frame selected as the target for the loop process in S505 is referred to as the target image frame.

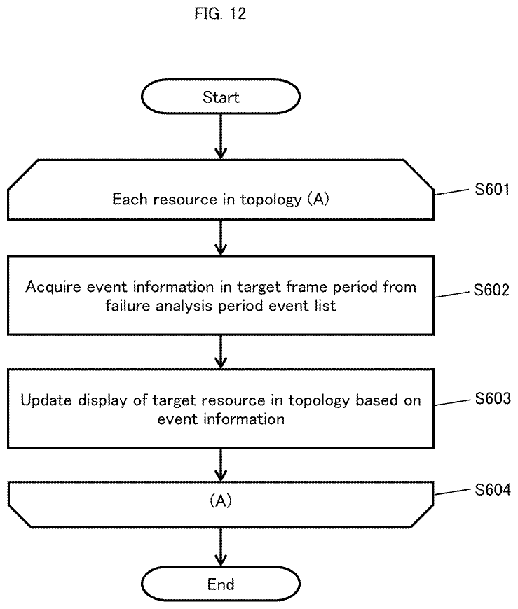

The resource status reproduction display unit 514 performs a topology display process of the target image frame (S507). Details of this processing will be described later (see FIG. 12).

In the resource status reproduction display unit 514, if all the image frames between the start time point and the end time point of the failure analysis period have been selected in S505, the processing ends, and if unselected image frame(s) remain in S505, the processing returns to S506 (S508).

FIG. 12 is a flowchart illustrating an example of the topology display process of the target image frame. This processing corresponds to the details of S506 in FIG. 11.

The resource status reproduction display unit 514 selects the resources constituting the topology in sequence, and performs a loop process from S601 to S604 (S601). The resource selected as the target for the loop process in S601 is referred to as the target resource.

The resource status reproduction display unit 514 acquires event information indicating the status of the target resource (event occurrence status) during a period of the target image frame from the failure analysis period event list (S602).

The resource status reproduction display unit 514 updates the display of the event of the target resource of the topology based on the event information of the target resource acquired in S602 (S603).

In the resource status reproduction display unit 514, if all the resources have been selected in S601, the processing ends, and if unselected resource(s) remain in S601, the processing returns to S601.

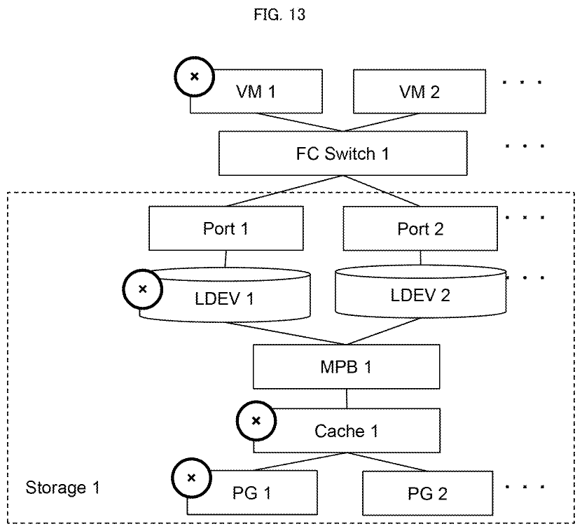

FIG. 13 illustrates a display example of events that have occurred in resources constituting a topology.

As illustrated in FIG. 13, the resource status reproduction display unit 514 displays a topology indicating a relationship between resources. Further, the resource status reproduction display unit 514 performs the topology display process illustrated in FIG. 12 on each image frame from the start time point to the end time point of the failure analysis period, so as to reproduce events that occurred in the resources as an animation as illustrated in FIG. 13. In the display update in S603, an X mark is displayed for the resource in which an error occurred at the timing of the image frame. FIG. 13 illustrates a display example at a certain timing in the reproduction display. As an example, errors have occurred in the respective resources having resource names of VM1, LDEV1, Cachet, and PG1. For example, VM1 is the resource name of a certain VirtualMachine, LDEV1 is the resource name of a certain LogicalDevice, Cache1 is the resource name of a certain Cache, and PG1 is the resource name of a certain RAIDGroup.

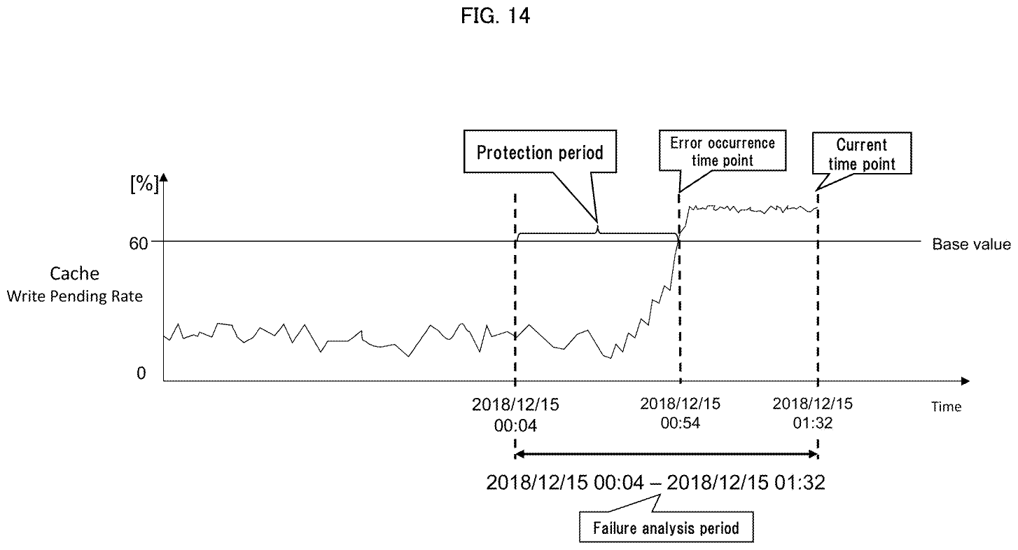

Next, a specific example of the above contents will be described with reference to FIGS. 14 to 20.

FIG. 14 illustrates a specific example of the failure analysis period identified by the failure analysis period identification unit 543. With reference to FIG. 14, a specific example of the predetermined calculation method for extracting an analysis period in S206 of FIG. 8 will be described.

In the graph of FIG. 14, the vertical axis indicates the cache write pending rate which is an example of the metric performance value, and the horizontal axis indicates the time. In the graph of FIG. 14, the base value is a threshold for determining whether or not an error has occurred, and when the cache write pending rate exceeds the base value, it is determined that an error has occurred.

The failure analysis period identification unit 543 identifies, as a failure analysis period, a period around an error occurrence time point of “2018/12/15 00:54” in the graph of FIG. 14. For example, in FIG. 14, the failure analysis period identification unit 543 sets, as the start time point of the failure analysis period, a time of “2018/12/15 00:04”, at which the cache write pending rate does not exceed the base value and which is a fixed period (hereinafter referred to as “protection period”) before the error occurrence time point. In FIG. 14, the failure analysis period identification unit 543 sets a current time point of “2018/12/15 01:32” as the end time point of the failure analysis period. It is noted that the failure analysis period identification unit 543 may set the time point at which the cache light pending rate becomes equal to or smaller than the base value as the end time point of the failure analysis period. In addition, the protection period and the base value may be defined in advance and stored in a storage unit.

That is, the failure analysis period identification unit 543 may perform the following processing. For each of the bottleneck candidate resources, the failure analysis period identification unit 543 calculates the start time point and the end time point as follows. The head time point of a period in which the metric performance value does not exceed the metric base value before the current time point and which is a duration of time corresponding to a predetermined protection period is set as the start time point. If the metric performance value exceeds the metric base value at the current time point, the current time point is set as the end time point. If the metric performance value does not exceed the metric base value at the current time point, the time point at which the metric performance value exceeded the metric base value last before the current time point is set as the end time point. Further, the failure analysis period identification unit 543 sets the earliest time point of the start time points calculated for the respective bottleneck candidate resources as the start time point of the failure analysis period, and sets the latest time point of the end time points calculated for the respective bottleneck candidate resources as the end time point of the failure analysis period.

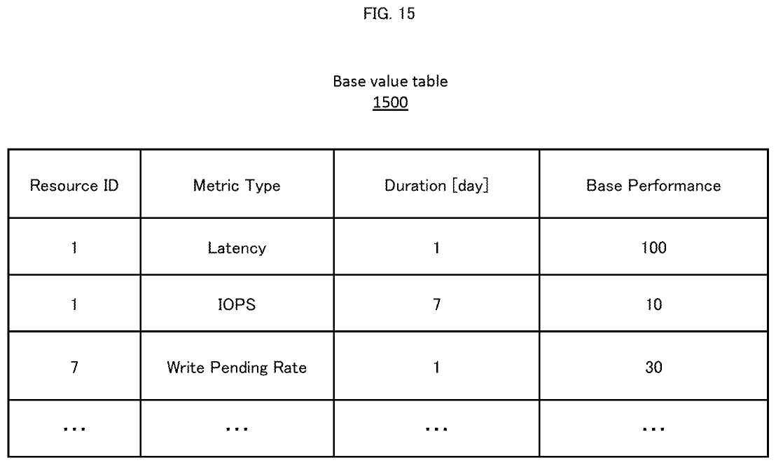

FIG. 15 illustrates an example of a base value table 1500.

The base value table 1500 is used to manage pieces of information related to base values of the respective metrics of resources as records. Each record has, as data items, a resource ID, a metric type, a duration of a metric performance value used for calculating a base value, and a base value. For example, the first line of the base value table 1500 illustrated in FIG. 15 indicates that the resource with a resource ID of “1” and a metric type of “Latency” has a base value of “100” and a duration of the metric performance value used for calculating the base value of “1 day”.

The base value may be dynamically changed based on the metric performance value during the duration of the metric performance value used for calculating the base value.

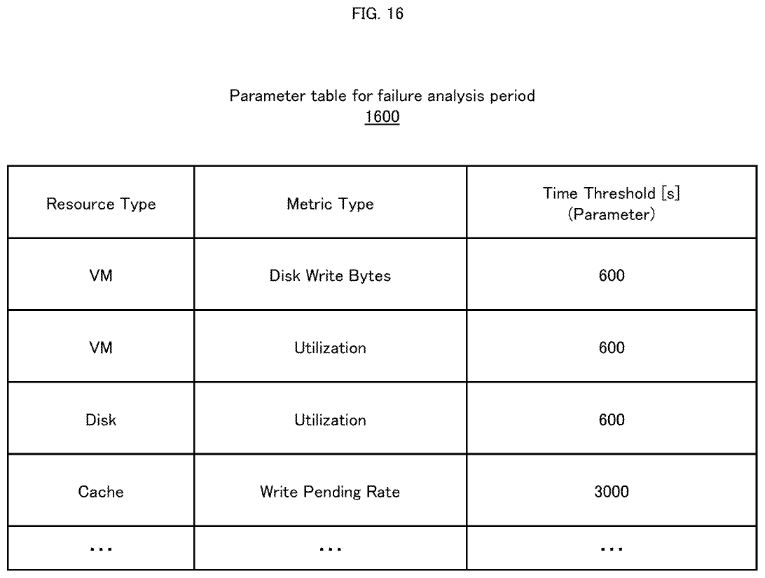

FIG. 16 illustrates an example of a parameter table 1600 for failure analysis period.

The parameter table 1600 for failure analysis period is used to manage parameters used for identifying a failure analysis period as records. Each record has, as data items, a resource type, a metric type, and a threshold for protection period. For example, the first line of the parameter table 1600 for failure analysis period illustrated in FIG. 16 indicates that the resource with a resource type of “VM” and a metric type of “Disk Write Byte” has a threshold for protection period of “600” seconds. That is, a period of 600 seconds or more in which the metric performance value does not exceed the base value is set as a protection period.

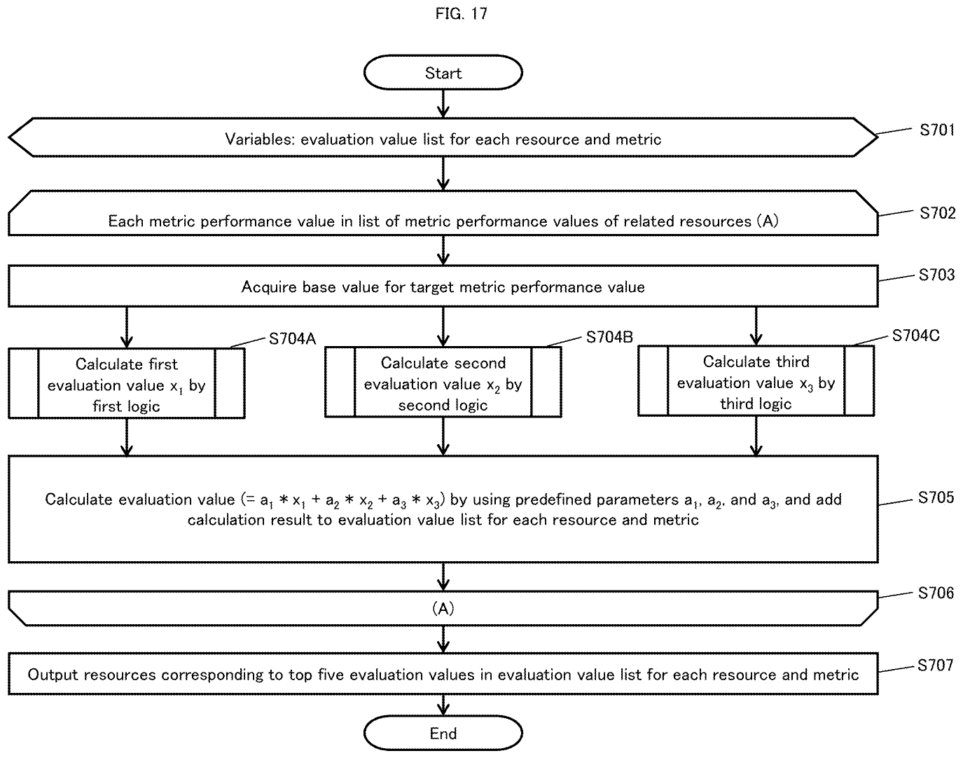

FIG. 17 is a flowchart illustrating an example of the calculation process for outputting the display resource list from the list of metric performance values of related resources. This processing corresponds to a specific example of S309 in FIG. 5.

The display resource identification unit 544 prepares variables for an evaluation value list for each of the resources and the metrics (S701).

The display resource identification unit 544 selects the metric performance values included in the list of metric performance values of related resources in sequence, and performs a loop process from S702 to S706 (S702). The metric performance value selected as the target for the loop process in S702 is referred to as the target metric performance value.

The display resource identification unit 544 acquires a base value corresponding to the target metric performance value from the base value table (S703).

The display resource identification unit 544 calculates a first evaluation value x₁ based on a first logic (S704A). Details of this processing will be described later (see FIG. 15).

The display resource identification unit 544 calculates a second evaluation value x₂ based on a second logic (S704B). Details of this processing will be described later (see FIG. 16).

The display resource identification unit 544 calculates a third evaluation value x₃ based on a third logic (S704C). Details of this processing will be described later (see FIG. 17).

The display resource identification unit 544 calculates a comprehensive evaluation value based on the first, second, and third evaluation values. For example, an evaluation value of a₁*x₁+a₂*x₂+a₃*x₃ is calculated. Here, a₁, a₂, and a₃ are predefined parameters. The display resource identification unit 544 adds the calculated evaluation value to an evaluation value list for each resource and metric (S705).

In the display resource identification unit 544, if all the metric performance values have been selected in S702, the processing proceeds to S707, and if unselected metric performance value(s) remain in S702, the processing returns to S702 (S706).

The display resource identification unit 544 outputs a resource corresponding to the top five evaluation values included in the evaluation value list for each resource and metric as a display resource list. Then, the processing ends. It is noted that here, the resources included in the display resource list are to-be-displayed bottleneck candidate related resources, which are resources to be additionally displayed in a topology composed of base point resources and base point-related resources.

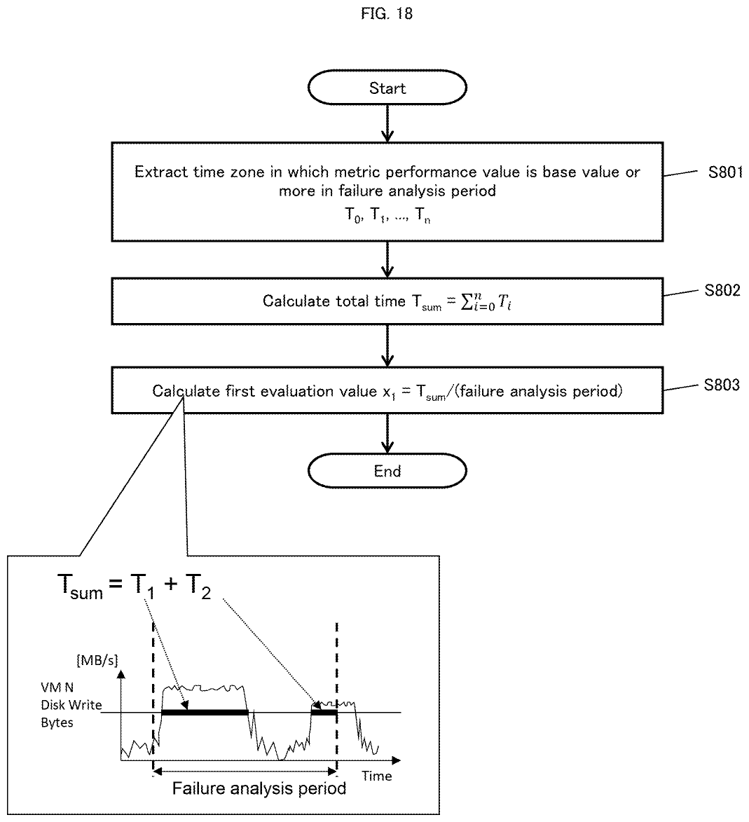

FIG. 18 is a flowchart illustrating an example of calculating the first evaluation value x₁ by the first logic. This processing corresponds to the details of S704A in FIG. 14.

The display resource identification unit 544 extracts a time zone (T₀, T₁, . . . , Tₙ) in which the metric performance value is equal to or larger than the base value from the failure analysis period (S801).

The display resource identification unit 544 calculates a total time Tₛᵤₘ according to the following Equation 1 (S802).

[Math. 1]

Tₛᵤₘ=Σᵢ₌₀ⁿTᵢ (Equation 1)

The display resource identification unit 544 calculates the first evaluation value x₁ (=Tₛᵤₘ/failure analysis period) (S803).

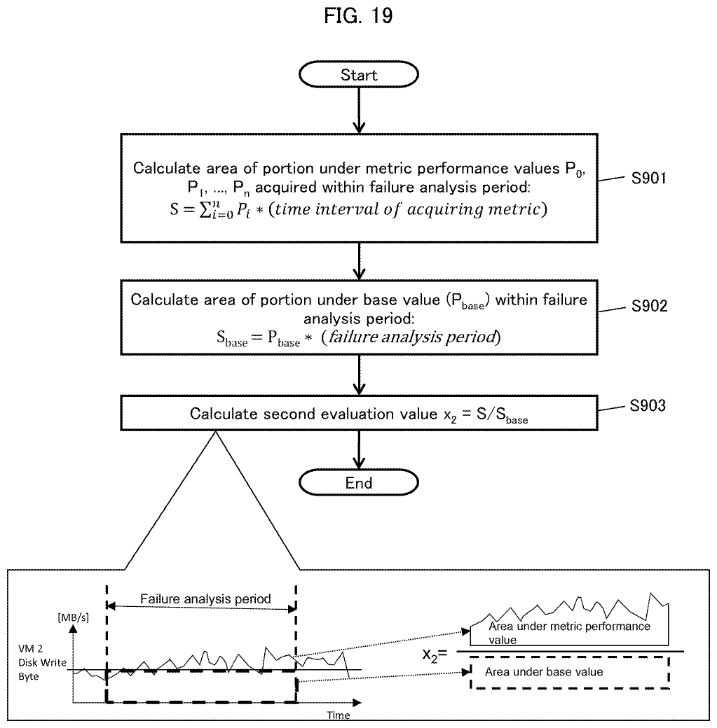

FIG. 19 is a flowchart illustrating an example of calculating the second evaluation value x₂ by the second logic. This processing corresponds to the details of S704B in FIG. 14.

The display resource identification unit 544 calculates an area S of a portion under metric performance values P₀, P₁, . . . , Pₙ within the failure analysis period (S901). The area S is calculated by the following Equation 2. In a graph that represents a metric performance value at each time point by a curve in the time axis and the metric axis, the area S is the area of a region between the time axis and the metric performance value curve in the failure analysis period.

[Math. 2]

S=Σᵢ₌₀ⁿPᵢ*(Time interval of acquiring metric) (Equation 2)

The display resource identification unit 544 calculates an area S_{base} (=P_{base}*(failure analysis period)) of a portion under a base value P_{base} within the failure analysis period (S902). In the graph, the area S_{base} is the area of a region between the time axis and the metric base values in the failure analysis period.

The display resource identification unit 544 calculates the second evaluation value x₂ (=S/S_{base}) (S903).

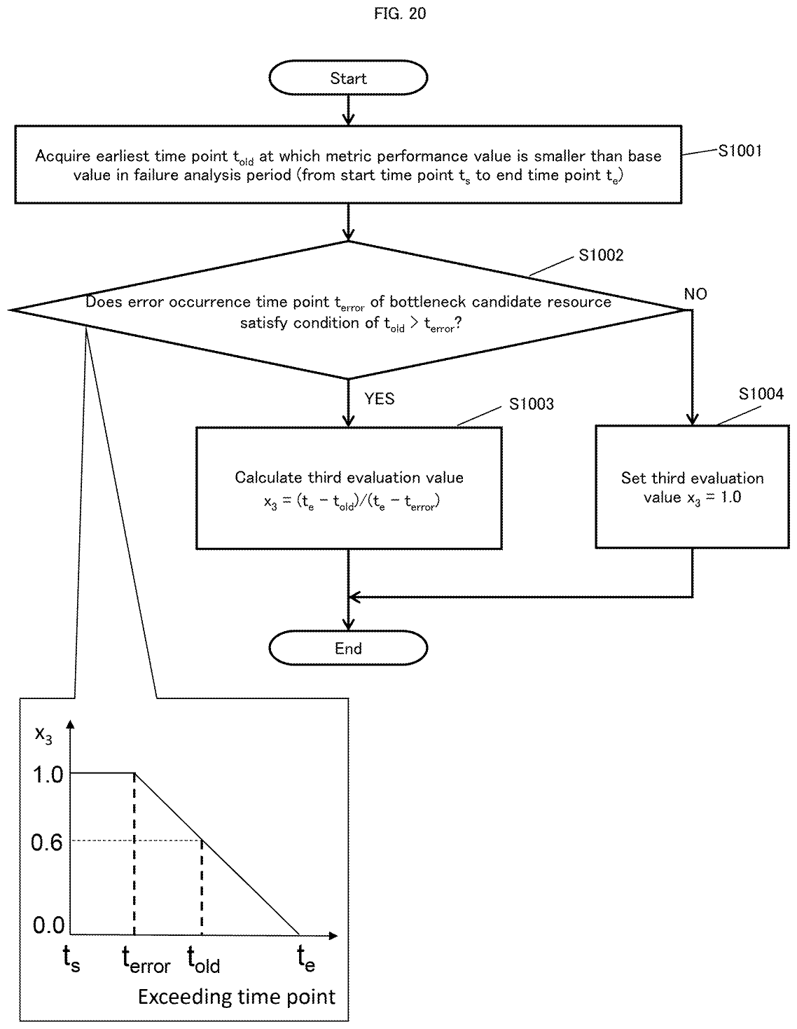

FIG. 20 is a flowchart illustrating an example of calculating the third evaluation value x₃ by the third logic. This processing corresponds to the details of S704C in FIG. 14.

The display resource identification unit 544 acquires the earliest time point t_{old} at which the metric performance value is smaller than the base value in the failure analysis period (from the start time point tₛ to the end time point tₑ) (S1001).

The display resource identification unit 544 determines whether or not an error occurrence time point tₑᵣᵣₒᵣ of the bottleneck candidate resource satisfies the of condition of t_{old}>tₑᵣᵣₒᵣ (S1002).

If the condition of t_{old}>tₑᵣᵣₒᵣ is satisfied (S1002: YES), the display resource identification unit 544 calculates the third evaluation value x₃ (=(tₑ−t_{old})/(tₑ−tₑᵣᵣₒᵣ)) (S1003).

If the condition of t_{old}>tₑᵣᵣₒᵣ is not satisfied (S1002: NO), the display resource identification unit 544 sets the third evaluation value x₃ to 1.0 (S1004).

### Summary of Present Embodiment

A failure analysis support system for supporting a failure analysis for a computer system including a plurality of resources, according to the present embodiment includes a management information storage unit configured to store inter-resource relation information indicating a relationship between the plurality of resources, metric base values that are each a base value determined for each metric of the plurality of resources, and metric performance values that are each a measured value of each metric of the plurality of resources at each time point; a failure analysis period identification unit 543 configured to identify a base point-related resource related to a base point resource that is a base point of the failure analysis by referring to the inter-resource relation information, display the base point resource and the base point-related resource to receive a designation of a bottleneck candidate resource, and calculate a failure analysis period that is a period of time to be subjected to the failure analysis based on a metric performance value of the bottleneck candidate resource and a metric base value corresponding to the metric performance value; a display resource identification unit 544 configured to identify a bottleneck candidate related resource related to the bottleneck candidate resource by referring to the inter-resource relation information, calculate an evaluation value of the bottleneck candidate related resource based on a metric performance value of the bottleneck candidate related resource and a metric base value corresponding to the metric performance value, and identify a to-be-displayed bottleneck candidate related resource that is a resource to be displayed from bottleneck candidate related resources based on the evaluation value; and a resource status reproduction display unit 514 configured to display a screen with an appearance to show a mutual relationship between display resources including the base point resource, the base point-related resource, the bottleneck candidate resource, and the to-be-displayed bottleneck candidate related resource, and a status of the display resources at each time point in the failure analysis period.

With this configuration, the failure analysis period and the display resource are identified based on the performance value and the base value, and display is performed with an appearance to show the mutual relationship between the display resources and the status of the display resources at each time point in the failure analysis period. Accordingly, it is possible to effectively support the failure analysis for the computer system.

The failure analysis period identification unit 543 is configured to: calculate a start time point and an end time point for each of the bottleneck candidate resources in a way that a head time point of a period in which the metric performance value does not exceed the metric base value before a current time point and which is a duration of time corresponding to a predetermined protection period is set as the start time point; if the metric performance value exceeds the metric base value at the current time point, the current time point is set as the end time point; if the metric performance value does not exceed the metric base value at the current time point, the time point at which the metric performance value exceeded the metric base value last before the current time point is set as the end time point; and set the earliest time point of the start time points calculated for the respective bottleneck candidate resources as the start time point of the failure analysis period, and set the latest time point of the end time points calculated for the respective bottleneck candidate resources as the end time point of the failure analysis period.

With this configuration, a period including a period in which the metric performance values of all the bottleneck candidate resources exceed the metric base value and the protection period before the period is set as the failure analysis period. Accordingly, it is possible to effectively support the failure analysis by displaying the status of each resource during a period that is likely to be affected by a failure.

The display resource identification unit 544 is configured to calculate, for each of the bottleneck candidate related resources, evaluation values by a plurality of evaluation logics based on the metric performance value and the metric base value, and calculate an evaluation value of the bottleneck candidate related resource by combining the evaluation values obtained by the respective evaluation logics.

With this configuration, the plurality of evaluation values are combined to calculate a comprehensive evaluation value of the bottleneck candidate related resource. Accordingly, it is possible to identify a display resource based on a comprehensive evaluation of the evaluations obtained from a plurality of viewpoints.

One of the plurality of evaluation logics is to calculate one of the evaluation values based on a ratio of a total of periods of time during which the metric performance value is equal to or larger than the metric base value within the failure analysis period to the failure analysis period.

One of the plurality of evaluation logics is to calculate one of the evaluation values based on a ratio of an area of a portion under the metric performance value in the failure analysis period to an area of a portion under the metric base value in the failure analysis period.

One of the plurality of evaluation logics is to calculate, when a failure occurrence time point in the bottleneck candidate resource is earlier than a past time point that is the earliest time point at which the metric performance value in the failure analysis period is the metric base value or less, one of the evaluation values based on a ratio of a period from the past time point to the last time point of the failure analysis period to a period from the failure occurrence time point to the last time point.

The resource status reproduction display unit 514 is configured to display the mutual relation between the display resources as a topology connecting the display resources. With this configuration, the mutual relation between the display resources is displayed in the topology. Accordingly, it is possible to effectively support the failure analysis in consideration of the relation between the resources.

The display resource identification unit 544 is configured to add, to the display resources, a resource that is on a path between the display resource and the bottleneck candidate resource and is not included in the display resources in the topology. With this configuration, since the resource between the display resource and the bottleneck candidate resource may be affected by a failure, additionally displaying the resource may make it possible to make the failure analysis easier.

The resource status reproduction display unit 514 is configured to set a display resource in which the metric performance value exceeds a predetermined base value to an error state, and display the topology with an appearance to show the display resource in the error state to be distinguishable from a display resource not in the error state at each time point of the failure analysis period. With this configuration, the display resource in the error state and the display resource not in the error state are distinguishably displayed in the topology. Accordingly, it is possible to make the failure analysis based on transition to the error state easier.

The present invention is not limited to the embodiments described above, and without departing from the spirit and scope of the present invention, all or some of the embodiments may be used in combination or a part of the configuration may be changed.

What is claimed is:

1. A failure analysis support system for supporting a failure analysis for a computer system including a plurality of resources, the failure analysis support system comprising:
a management information storage unit configured to store inter-resource relation information indicating a relationship between the plurality of resources, metric base values that are each a base value determined for each metric of the plurality of resources, and metric performance values that are each a measured value of each metric of the plurality of resources at each time point;
a failure analysis period identification unit configured to identify a base point-related resource related to a base point resource that is a base point of the failure analysis by referring to the inter-resource relation information, display the base point resource and the base point-related resource to receive a designation of a bottleneck candidate resource, and calculate a failure analysis period that is a period of time to be subjected to the failure analysis based on a metric performance value of the bottleneck candidate resource and a metric base value corresponding to the metric performance value;
a display resource identification unit configured to identify a bottleneck candidate related resource related to the bottleneck candidate resource by referring to the inter-resource relation information, calculate an evaluation value of the bottleneck candidate related resource based on a metric performance value of the bottleneck candidate related resource and a metric base value corresponding to the metric performance value, and identify a to-be-displayed bottleneck candidate related resource that is a resource to be displayed from the bottleneck candidate related resource based on the evaluation value; and
a resource status reproduction display unit configured to display a screen with an appearance to show a mutual relationship between display resources including the base point resource, the base point-related resource, the bottleneck candidate resource, and the to-be-displayed bottleneck candidate related resource, and a status of the display resources at each time point in the failure analysis period.

2. The failure analysis support system according to claim 1, wherein
the failure analysis period identification unit is configured to
calculate a start time point and an end time point for each bottleneck candidate resource in a way that a head time point of a period in which the metric performance value does not exceed the metric base value before a current time point and which is a duration of time corresponding to a predetermined protection period is set as the start time point; if the metric performance value exceeds the metric base value at the current time point, the current time point is set as the end time point; if the metric performance value does not exceed the metric base value at the current time point, a time point at which the metric performance value exceeded the metric base value last before the current time point is set as the end time point, and
set the earliest time point of the start time point calculated for the bottleneck candidate resource as the start time point of the failure analysis period, and set the latest time point of the end time point calculated for the bottleneck candidate resource as the end time point of the failure analysis period.

3. The failure analysis support system according to claim 1, wherein the display resource identification unit is configured to calculate, for the bottleneck candidate related resource, evaluation values by a plurality of evaluation logics based on the metric performance value and the metric base value, and calculate an evaluation value of the bottleneck candidate related resource by combining the evaluation values obtained by the evaluation logics.

4. The failure analysis support system according to claim 3, wherein one of the plurality of evaluation logics is to calculate one of the evaluation values based on a ratio of a total of periods of time during which the metric performance value is equal to or larger than the metric base value within the failure analysis period to the failure analysis period.

5. The failure analysis support system according to claim 3, wherein one of the plurality of evaluation logics is to calculate one of the evaluation values based on a ratio of, in a graph that represents a metric performance value at each time point by a curve in a time axis and a metric axis, an area of a region between the time axis and the curve in the failure analysis period to an area of a region between the time axis and the metric base value in the failure analysis period.

6. The failure analysis support system according to claim 3, wherein one of the plurality of evaluation logics is to calculate, when a failure occurrence time point in the bottleneck candidate resource is earlier than a past time point that is the earliest time point at which the metric performance value in the failure analysis period is equal to or smaller than the metric base value, one of the evaluation values based on a ratio of a period from the past time point to a last time point of the failure analysis period to a period from the failure occurrence time point to the last time point.

7. The failure analysis support system according to claim 1, wherein the resource status reproduction display unit is configured to display the mutual relation between the display resources as a topology connecting the display resources.

8. The failure analysis support system according to claim 7, wherein the display resource identification unit is configured to add, to the display resources, a resource that is on a path between the display resources and the bottleneck candidate resource and is not included in the display resources in the topology.

9. The failure analysis support system according to claim 7, wherein the resource status reproduction display unit is configured to set a display resource in which the metric performance value exceeds a predetermined base value to an error state, and display the topology with an appearance to show the display resource in the error state to be distinguishable from a display resource not in the error state at each time point of the failure analysis period.

10. A failure analysis support method for supporting a failure analysis for a computer system including a plurality of resources, the failure analysis support method comprising:
storing, in a management information storage unit, inter-resource relation information indicating a relationship between the plurality of resources, metric base values that are each a base value determined for each metric of the plurality of resources, and metric performance values that are each a measured value of each metric of the plurality of resources at each time point;
identifying a base point-related resource related to a base point resource that is a base point of the failure analysis by referring to the inter-resource relation information, display the base point resource and the base point-related resource to receive a designation of a bottleneck candidate resource, and calculating a failure analysis period that is a period of time to be subjected to the failure analysis based on a metric performance value of the bottleneck candidate resource and a metric base value corresponding to the metric performance value;
identifying a bottleneck candidate related resource related to the bottleneck candidate resource by referring to the inter-resource relation information, calculating an evaluation value of the bottleneck candidate related resource based on a metric performance value of the bottleneck candidate related resource and a metric base value corresponding to the metric performance value, and identifying a to-be-displayed bottleneck candidate related resource that is a resource to be displayed from the bottleneck candidate related resource based on the evaluation value; and
displaying a screen with an appearance to show a mutual relationship between display resources including the base point resource, the base point-related resource, the bottleneck candidate resource, and the to-be-displayed bottleneck candidate related resource, and a status of the display resources at each time point in the failure analysis period.

11. A non-transitory computer-readable recording medium containing a computer program for supporting a failure analysis for a computer system including a plurality of resources, the program causing a computer to execute:
storing, in a management information storage unit, inter-resource relation information indicating a relationship between the plurality of resources, metric base values that are each a base value determined for each metric of the plurality of resources, and metric performance values that are each a measured value of each metric of the plurality of resources at each time point;
identifying a base point-related resource related to a base point resource that is a base point of the failure analysis by referring to the inter-resource relation information, display the base point resource and the base point-related resource to receive a designation of a bottleneck candidate resource, and calculating a failure analysis period that is a period of time to be subjected to the failure analysis based on a metric performance value of the bottleneck candidate resource and a metric base value corresponding to the metric performance value;
identifying a bottleneck candidate related resource related to the bottleneck candidate resource by referring to the inter-resource relation information, calculating an evaluation value of the bottleneck candidate related resource based on a metric performance value of the bottleneck candidate related resource and a metric base value corresponding to the metric performance value, and identifying a to-be-displayed bottleneck candidate related resource that is a resource to be displayed from the bottleneck candidate related resource based on the evaluation value; and
displaying a screen with an appearance to show a mutual relationship between display resources including the base point resource, the base point-related resource, the bottleneck candidate resource, and the to-be-displayed bottleneck candidate related resource, and a status of the display resources at each time point in the failure analysis period.
